(19) United States
(12) Patent Application Publication
(10) Pub. No.: US 2026/0138578 A1
(43) Pub. Date: May 21, 2026

(54) FLOW INTENSIFIER AND BRAKE SYSTEMS USING SAME

(71) Applicant: ZF Active Safety US Inc., Livonia, MI (US)

(72) Inventor: Blaise J. Ganzel, Lakeport, MI (US)

(21) Appl. No.: 18/950,713

(22) Filed: Nov. 18, 2024

(51) Int. Cl. B60T 13/16; B60T 13/66

(52) U.S. Cl. CPC B60T 13/165; B60T 13/662; B60T 2270/402

(57) ABSTRACT

A nonpowered flow intensifier includes an intensifier cavity having longitudinally spaced first and second cavity ends. An intensifier piston is configured for selective reciprocal motion within the intensifier cavity. The intensifier piston includes a piston head portion longitudinally adjacent the first cavity end and a piston skirt portion extending from the piston head portion. A piston lateral bore extends in a lateral direction at least partially through a solid body of the piston head portion and in fluid communication with the intensifier cavity. A piston reducer bore places the piston lateral bore and an internal void of the piston skirt portion in fluid communication. Pressurized hydraulic fluid travels along an intensifier input fluid path at least from a fluid input port, through at least a portion of the intensifier cavity, the piston lateral bore, and the piston reducer bore, and exits the intensifier cavity via a fluid output port.

### TECHNICAL FIELD

This disclosure relates to an apparatus and method for use of a flow intensifier and a brake system using same, and, more particularly, to methods and apparatuses of brake systems with flow intensifiers facilitating fast fill of selected wheel brakes.

### BACKGROUND

A brake system may include anti-lock control including a hydraulic braking pressure generator, a braking pressure modulator which is provided in the pressure fluid conduits between the braking pressure generator and the wheel brakes and which serves to vary the braking pressure by changing the volume of a chamber containing the hydraulic fluid, sensors for determining the wheel rotational behavior, and electronic circuits for processing the sensor signals and for generating braking-pressure control signals. Brake systems may also include both anti-lock control and traction slip control, which can use braking pressure modulators for controlled vehicular braking.

It may be desirable to provide pressurized hydraulic fluid to a brake on an expedited basis, for some use environments (e.g., a “spike apply”, when the user “slams on” the brakes). Therefore, storage of pressurized hydraulic fluid in closer proximity to the brakes than the source(s) of the pressurized hydraulic fluid may be helpful in facilitating quick braking response, in some use environments.

For example, some brake systems include a “running clearance” distance between the brake pads and rotors, to avoid unwanted drag and wear on the brakes when they are not in use. Particularly in a “spike apply” situation, a user may wish to quickly take up that running clearance distance, to avoid a delay (or the perception thereof by a driver) in brake actuation.

Descriptions of prior art brake systems are in U.S. Pat. No. 10,730,501, issued 4 Aug. 2020 to Blaise Ganzel and titled “Vehicle Brake System with Auxiliary Pressure Source”, in U.S. Patent Application Publication No. 2020/0307538, published 1 Oct. 2020 by Blaise Ganzel and titled “Brake System with Multiple Pressure Sources”, and in U.S. Patent Application Publication No. 2023/0048447, published 16 Feb. 2023 by Blaise Ganzel and titled “Apparatus and Method for Control of a Hydraulic Brake System Including Manual Pushthrough”, all of which are incorporated herein by reference in their entirety for all purposes.

### SUMMARY

In an aspect, alone or in combination with any other aspect, a nonpowered flow intensifier is described. The nonpowered flow intensifier, comprises an intensifier housing and an intensifier cavity at least partially defined by the intensifier housing. The intensifier cavity has longitudinally spaced first and second cavity ends with a central cavity axis extending longitudinally therebetween. An intensifier piston is configured for selective longitudinally reciprocal motion within the intensifier cavity, at least partially responsive to fluid pressure within the intensifier cavity. The intensifier piston includes a piston head portion longitudinally adjacent the first cavity end and a piston skirt portion extending from the piston head portion toward the second cavity end. A piston lateral bore extends in a lateral direction at least partially through a solid body of the piston head portion and in fluid communication with the intensifier cavity via at least one lateral bore outlet of the piston head portion. A piston reducer bore places the piston lateral bore and an internal void of the piston skirt portion in fluid communication. A fluid input port is interposed longitudinally between the first and second cavity ends and places the intensifier cavity in fluid communication with a source of pressurized hydraulic fluid. A fluid output port is located at the second cavity end and places the intensifier cavity in fluid communication with a wheel brake. Pressurized hydraulic fluid travels along an intensifier input fluid path at least from the fluid input port, through at least a portion of the intensifier cavity, the piston lateral bore, the piston reducer bore, and the internal void of the piston skirt, and exits the intensifier cavity via the fluid output port.

In an aspect, alone or in combination with any other aspect, a brake system for actuating a plurality of wheel brakes comprising first and second pairs of wheel brakes is described. The system comprises a reservoir and a motor-driven master cylinder operable during a normal non-failure braking mode by actuation of an electric motor of the master cylinder to generate brake actuating pressure at first and second MC outputs for hydraulically actuating the first and second pairs of wheel brakes, respectively. A secondary brake module is configured for selectively providing pressurized hydraulic fluid at first and second pump outputs for actuating the first and second pairs of wheel brakes in at least one of a normal non-failure braking mode and a backup braking mode. The secondary brake module includes an electric pump motor configured to selectively pressurize the hydraulic fluid by transmitting rotary motion to at least two pump pistons. Each pump piston provides pressurized hydraulic fluid to a corresponding one of the first and second pump outputs. Each of the first and second pump outputs provides fluid to a corresponding one of the first and second pairs of wheel brakes. First and second intensifier assemblies are provided, with each intensifier assembly being interposed hydraulically between a corresponding first or second MC output and at least one wheel brake of a corresponding first or second pair of wheels. Each of the first and second intensifier assemblies includes a nonpowered flow intensifier. The intensifier includes an intensifier housing and an intensifier cavity at least partially defined by the intensifier housing. The intensifier cavity has longitudinally spaced first and second cavity ends with a central cavity axis extending longitudinally therebetween. An intensifier piston is configured for selective longitudinally reciprocal motion within the intensifier cavity, at least partially responsive to fluid pressure within the intensifier cavity. The intensifier piston includes a piston head portion longitudinally adjacent the first cavity end and a piston skirt portion extending from the piston head portion toward the second cavity end. A piston lateral bore extends in a lateral direction at least partially through a solid body of the piston head portion and in fluid communication with the intensifier cavity via at least one lateral bore outlet of the piston head portion. A piston reducer bore places the piston lateral bore and an internal void of the piston skirt portion in fluid communication. A fluid input port is interposed longitudinally between the first and second cavity ends and places the intensifier cavity in fluid communication with a respective first or second MC output. A fluid output port is located at the second cavity end and places the intensifier cavity in fluid communication with a respective wheel brake. An electronic control unit is provided for controlling at least one of the secondary brake module and the master cylinder responsive to at least one braking signal. The first and second intensifier assemblies each facilitate a rapid filling operation for low drag brake calipers of the respective wheel brakes.

### BRIEF DESCRIPTION OF THE DRAWINGS

For a better understanding, reference may be made to the accompanying drawings, which are not drawn to scale, and in which:

FIG. 1 is a schematic cross-sectional view of a component of an example brake system;

FIG. 2 is a schematic cross-sectional view of an example use configuration of the component of FIG. 1, in a first condition;

FIG. 3 is a schematic cross-sectional view of an example use configuration of the component of FIG. 1, in a second condition;

FIG. 4 is a schematic cross-sectional view of an example use configuration of the component of FIG. 1, in a third condition;

FIG. 5 is a schematic cross-sectional view of an example use configuration of the component of FIG. 1, in a fourth condition;

FIG. 6 is a schematic hydraulic diagram of an example brake system incorporating the components of FIGS. 2-5;

FIG. 7 is a detail view of area “7” of FIG. 6;

FIG. 8 is a schematic front view of an example physical arrangement of the brake system of FIG. 6;

FIG. 9 is a schematic rear view of an example physical arrangement of the brake system of FIG. 6; and

FIG. 10 is a schematic hydraulic diagram of another example brake system.

### DESCRIPTION OF ASPECTS OF THE DISCLOSURE

Unless defined otherwise, all technical and scientific terms used herein have the same meaning as is commonly understood by one of ordinary skill in the art to which the present disclosure pertains.

The invention comprises, consists of, or consists essentially of the following features, in any combination.

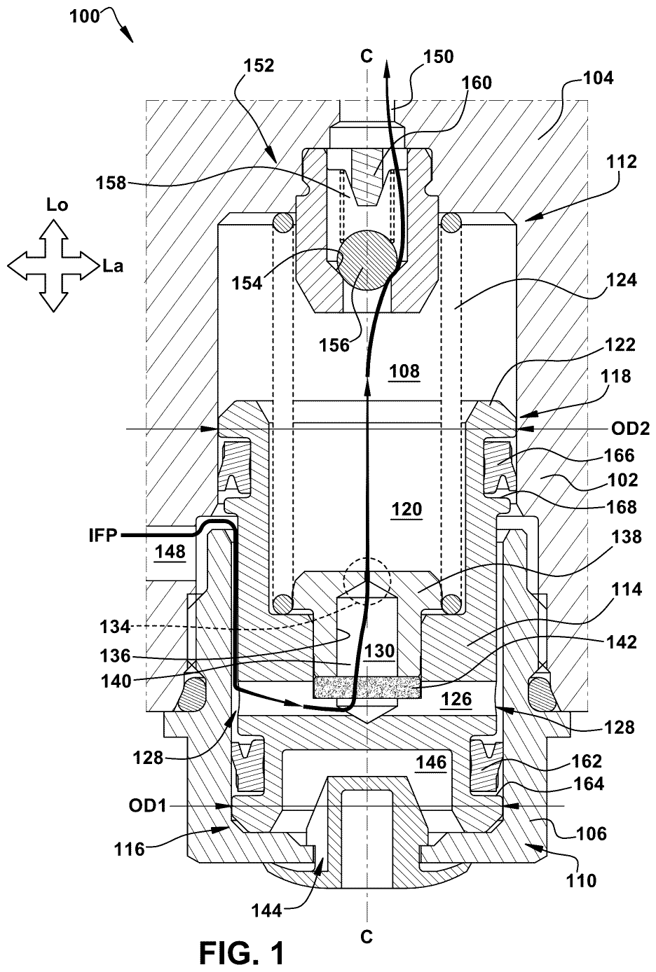

FIG. 1 schematically depicts a nonpowered flow intensifier 100, comprising an intensifier housing 102. The intensifier 100 may be helpful in providing a “fast fill” function, for example, in a brake system including low drag calipers, while still providing non-powered evac and fill capability to the brake system. The intensifier 100 can help take up running clearance quickly in the low drag type calipers, where significant amounts of hydraulic fluid need to be moved quickly to provide rapid brake response, as compared to traditional arrangements having the brake pads riding more closely to the brake rotor in a non-apply portion of the duty cycle.

The intensifier 100 can be housed in the intensifier housing 102, shown schematically in the Figures, which may define components of the intensifier 100; assist with assembling and maintaining components of the intensifier 100 into an assembled device; and/or provide other housing, assembly, and/or maintenance functions as desired to any other components of the brake system. The intensifier housing 102 may be cooperatively formed, in the example configuration of the Figures, by a bore in a brake system housing block 104 and a cap 106 attached to the brake system housing block 104.

An intensifier cavity 108 is at least partially defined by the intensifier housing 104. The intensifier cavity 108 has longitudinally spaced first and second cavity ends 110 and 112, respectively, with a central cavity axis (“C” in FIG. 1) extending longitudinally therebetween. The “longitudinal” direction, as referenced herein pertaining to the intensifier 100, is substantially parallel to arrow “Lo”, and is depicted as a vertical direction, in the orientation of FIG. 1.

An intensifier piston 114 is configured for selective longitudinally reciprocal motion within the intensifier cavity 108, at least partially responsive to fluid pressure within the intensifier cavity 108. The intensifier piston 114 includes a piston head portion 116 located longitudinally adjacent the first cavity end 110, and a piston skirt portion 118 extending from the piston head portion 116 toward the second cavity end 112 in a “cup” type manner. An internal surface 120 of the piston skirt portion 118 includes a laterally extending internal piston face 122 against which an intensifier piston spring 124 may act to urge the intensifier piston 114 toward the first cavity end 110. Alternatively or additionally, though, it is contemplated that a master cylinder, pump piston of a secondary brake module, or any other desired source of pressurized hydraulic fluid can be configured and controlled to refill the intensifier cavity 108, whether or not the intensifier piston spring 124 is provided.

A piston lateral bore 126 extends in a lateral direction at least partially through a solid body of the piston head portion 116. The “lateral” direction, as referenced herein, is substantially perpendicular to the longitudinal direction and parallel to arrow “La”, and is depicted as a horizontal direction, in the orientation of FIG. 1. The piston lateral bore 126 is in fluid communication with the intensifier cavity 108 via at least one lateral bore outlet 128 of the piston head portion 116. The lateral bore outlet 128 is defined by an intersection of the piston lateral bore 126 with an outer surface of the solid body of the piston head portion 116.

A piston reducer bore 130 places the piston lateral bore 122 and an internal void 132 of the piston skirt portion 118 in fluid communication. As can be seen in FIG. 1, the piston reducer bore 130 includes a “necked down” or reduced-diameter orifice portion 134 which provides desired flow properties to hydraulic fluid flowing therethrough. The piston reducer bore 130 and/or the piston lateral bore 126 may be integrally formed with at least a portion of the intensifier piston 114, such as by being produced using forging, molding, machining, additive manufacturing, any other manufacturing technique, or any combination thereof. Alternatively, at least a portion of the piston reducer bore 130 and/or the piston head can be provided to the intensifier piston 114 at least partially via assembly of a plurality of subcomponents, such as to reduce cost, manufacturing time, manufacturing complexity, physical interferences, and/or for any other desired reason.

As an example, and as shown in FIG. 1, the internal piston face 122 may include a reducer recess 136 extending into a solid body of the piston head portion 116. The reducer recess 136 is in fluid communication with the piston lateral bore 126. The piston reducer bore 130 may be at least partially defined by a reducer plug 138 carried at least partially within the reducer recess 136 and defining a center plug bore 140 which comprises a portion of the piston reducer bore 130. The center plug bore 140 may have a first plug diameter which is adjacent the piston lateral bore 126 and a second plug diameter which is adjacent the piston skirt portion 118 and longitudinally spaced from the first plug diameter along the center plug bore 140. When the center plug bore 140 is tapered, the second plug diameter may be different than—e.g., larger or smaller than—the first plug diameter. For example, the center plug bore 140 shown in the Figures has a second plug diameter, adjacent the orifice portion 134, which is a superminority of the first plug diameter. For example, in some use applications for the flow intensifier 100, the orifice portion 134 (and thus the second plug diameter of the center bore 140 directly adjacent the orifice portion 134) may be in the range of 0.3-0.4 mm diameter.

A filter 142 may be interposed longitudinally between the reducer plug 138 and at least a portion of the piston lateral bore 126 for any desired reason such as, but not limited to, avoiding entry of debris or other unwanted material into the internal void 132 and points downstream.

A vent 144 to atmospheric pressure may be located at the first cavity end 110. When present, a surface of the piston head portion 116 which is directly adjacent the vent 144 may include a longitudinally extending vent bore 146 to accommodate extension of the vent 144 structure thereinto. Meanwhile, a portion of the surface of the piston head portion 116 which does not include the vent bore 146 is laterally adjacent to at least a portion of the vent 144 structure. That is, and as shown in FIG. 1, the vent bore 146 provides a cavity in the piston head portion 116 which “cups” the vent 144 when the intensifier piston 114 is located closely adjacent (e.g., in or near direct contact with) the first cavity end 110, so that the vent 144 does not prevent or “block” at least a circumferential rim portion of the piston head portion 116 from contacting the first cavity end 110.

A fluid input port 148 is interposed longitudinally between the first and second cavity ends 110 and 112, and places the intensifier cavity 108 in fluid communication with a source of pressurized hydraulic fluid. Similarly, a fluid output port 150 is located at the second cavity end 112 and places the intensifier cavity 108 in fluid communication with a wheel brake. Pressurized hydraulic fluid travels along an intensifier input fluid path (shown schematically at IFP in the Figures) at least from the fluid input port 148, through at least a portion of the intensifier cavity 108, the piston lateral bore 126, the piston reducer bore 130, and the internal void 132 of the piston skirt 118, and exits the intensifier cavity 108 via the fluid output port 150. As a result, the pressurized hydraulic fluid can be “intensified” by experiencing a pressure boost (by the flow intensifier 100) between the source of pressurized hydraulic fluid and the wheel brake, but is not stored under pressure as with prior art accumulators. Accordingly, the pressurized hydraulic fluid used with the flow intensifier 100 does not tend to “leak down”. The flow intensifier 100 portion of a brake system may be particularly helpful, for example, when the hydraulic fluid is cold (i.e., viscous) and it is desirable to send a predetermined pressure down to the wheel brake. It should be noted that, in cases with very low flow, then the pressurized hydraulic fluid travels through the orifice portion 134 largely unrestricted and substantially no flow intensification (more flow out than in) or intensifier piston 114 movement occurs. When the flow is higher, then the intensifier piston 114 moves within the intensifier cavity 108 to “push” fluid toward the wheel brake—i.e., more fluid exits the intensifier cavity 108 than enters. Air volume under the vent 144 increases (the air pressure decreases) and this equals the increase in usable liquid volume. The vent 144 lets air out of the flow intensifier 100, but prevents airflow in from the ambient space.

The fluid output port 150 includes a port check valve 152 resisting fluid flow “backward” along the IFP from the wheel brake toward the intensifier cavity. The port check valve 150 may include a check valve seat 154 and a check valve ball 156 urged toward the first cavity end 110 and into engagement with the check valve seat 154 by a check valve spring 158. A spring retainer 160 prevents egress of the check valve spring 158 from the port check valve 150. The check valve ball 156 is longitudinally interposed between the check valve seat 154 and the spring retainer 160. The port check valve 152, when present, can resist backflow from the brake moving hydraulic fluid from the brake at above atmospheric pressure and back into the intensifier cavity 108 in an undesirable manner. While the port check valve 152 is shown at least partially extending into the intensifier cavity 108 in the Figures, it is contemplated that the port check valve 152 could instead be spaced apart from the remaining components of the flow intensifier 102 by being placed further along the fluid output port 150 or any other suitable hydraulic passage fluidically interposed between the flow intensifier 100 and the wheel brake, and may be positioned as desired for a particular use environment by one of ordinary skill in the art.

The intensifier piston 114 may include a stepped outer profile shape as shown in the Figures, with a total outer diameter (shown schematically at “OD1”) of the intensifier piston 114 adjacent the first cavity end 110 being smaller than a total outer diameter (shown schematically at “OD2”) of the intensifier piston 114 adjacent the second cavity end 112. The intensifier piston 114 may include a first lip seal 162 carried within a first lip seal groove 164 at least partially circumferentially surrounding the piston head portion 116 and resisting fluid flow in a direction from the second cavity end 112 toward the first cavity end 110 (downward, in the orientation of FIG. 1). Similarly, a second lip seal 166 may be carried within a second lip seal groove 168 at least partially circumferentially surrounding the piston skirt portion 118 and resisting fluid flow in a direction from the first cavity end 110 toward the second cavity end 112.

Accordingly, an annular volume is defined laterally between the intensifier piston 114 and the intensifier housing 102 and longitudinally between the first and second lip seals 162 and 166. This annular volume size may be predetermined in relation to the orifice portion 134, the piston lateral bore 126, and/or any other structure(s) of the flow intensifier 100 in order to provide desired flow intensifier 100 function for a particular use environment, such as by allowing pressurized hydraulic fluid from the fluid input port 148 to exert a motive force against at least a portion of the intensifier piston 114 and thus achieve desired hydraulic results. For example, and as shown in the Figures, the second lip seal groove 168 may be carried in an increased-diameter stepped area (i.e., an area of OD2) of the piston skirt portion 118, with the stepped area including a piston shoulder 170 longitudinally interposed between the second lip seal groove 168 and the lateral bore outlet 128. As a result, pressurized hydraulic fluid from the fluid input port 148 which enters the annular volume (instead of passing through the piston lateral bore 126) pushes against the piston shoulder 170 to urge the intensifier piston 114 toward the second cavity end 112, optionally against biasing force provided by any provided intensifier piston spring 124.

In summary, the flow intensifier 100 can serve to effectively “convert” low flow/high pressure hydraulic fluid to high flow/ow pressure hydraulic fluid, as desired during certain phases of brake system operation. The flow intensifier 100 could also be thought of, conceptually, as a hydraulic transmission which allows more efficient use of motor power. Flow through the flow intensifier 100 bypasses the iso valves of the iso/dump control valve arrangements (as described below) to assist with keeping the flow intensifier 100 output pressure (at fluid output port 150) below a predetermined value, which will be a relatively low value for many use environments.

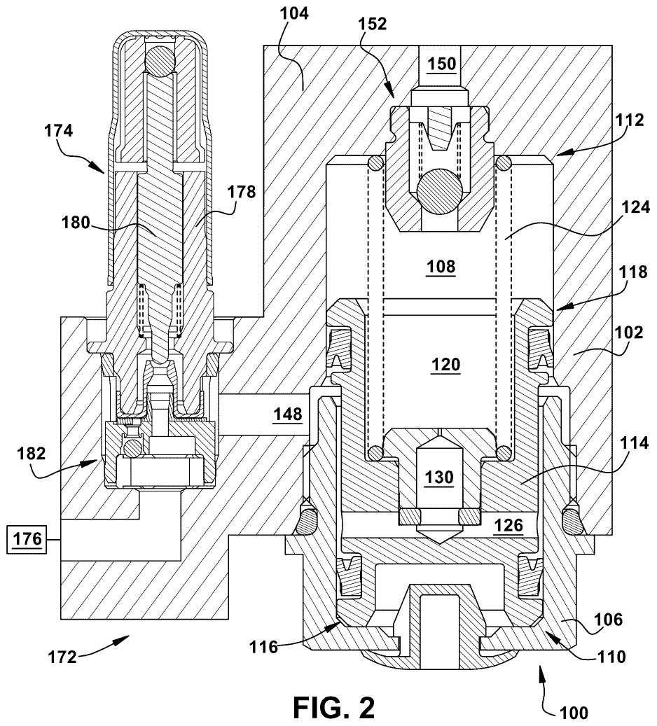

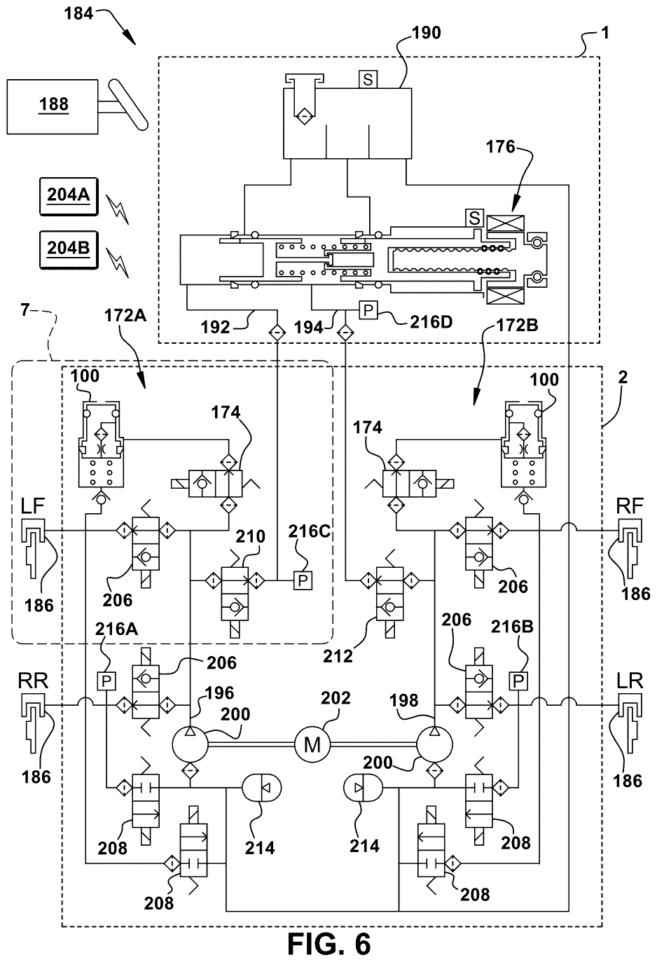

FIGS. 2-5 schematically depict various conditions of an example use configuration of an intensifier assembly 172 comprising a nonpowered flow intensifier 100 as described above and a the source of pressurized hydraulic fluid—shown schematically at 176 and discussed further below with reference to FIGS. 6-7 and 10 as master cylinder 176—and the flow intensifier 100. The bypass iso valve 174 may be a normally open type bypass iso valve or a normally closed type bypass iso valve. For example, and as shown in FIGS. 2-5, the bypass iso valve 174 has an armature-driven core 178 which moves a poppet 186 to selectively permit normally-open flow therethrough from the master cylinder 176 to the fluid input port 148 of the flow intensifier 100, but may include an optional check valve (shown generally at 182) function which prevents undesired flow of hydraulic fluid from the master cylinder 176 toward the flow intensifier 100. For many brake systems, it will be desirable to provide a bypass iso valve 174 having a relatively low valve restriction value, to facilitate fast-fill of the wheel brakes—i.e., the designer will likely strive for a large orifice in the bypass iso valve 174 while balancing the ability of the bypass iso valve 174 to still hold off pressure with the solenoid of the armature-driven core 178. The bypass iso valve 174 may be configured and constructed in any desired manner, and may readily be provided by one of ordinary skill in the art for a desired use environment.

FIGS. 2-5 schematically depict various conditions of the flow intensifier 100 and the bypass iso valve 174 during a duty cycle of the brake system. In FIG. 2, the bypass iso valve 174 is de-energized (i.e., open to allow flow) and the flow intensifier 100 is retracted, with the intensifier piston 114 racked toward the first cavity end 110. There is substantially no hydraulic fluid flowing through the intensifier assembly 172 of FIG. 2, and the intensifier cavity 108 is substantially full of fluid. FIG. 2 accordingly depicts a “rest” position of the intensifier assembly 172, with no brake apply occurring and/or during a slow brake apply under certain conditions such as, but not limited to, an open bypass iso valve 174.

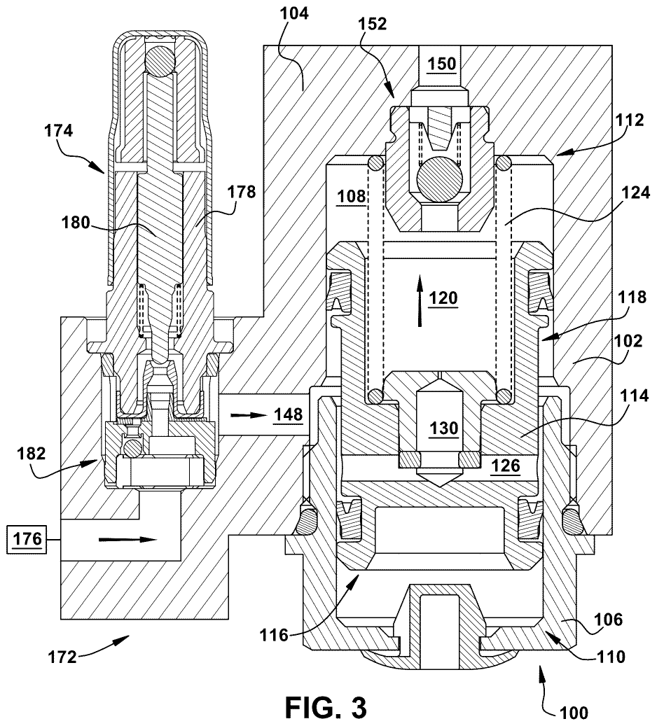

Turning to FIG. 3, the bypass iso valve 174 is still de-energized (i.e., open), and a fast-apply situation is occurring for the wheel brakes—the brakes have been “slammed on”. As a result, hydraulic fluid is flowing from the master cylinder 176, through the bypass iso valve 174, and through the fluid input port 148 into the flow intensifier 100. More volume of hydraulic fluid is exiting the fluid output port 150 than is coming in through the fluid input port 148. Thus, in the effort to quickly provide a large amount of pressurized hydraulic fluid to the wheel brake (e.g., to take up a large running clearance), the intensifier piston 114 is advancing—i.e., moving toward the second cavity end 112, or upward, in the orientation of FIG. 3—as the fluid egresses from the fluid output port 150.

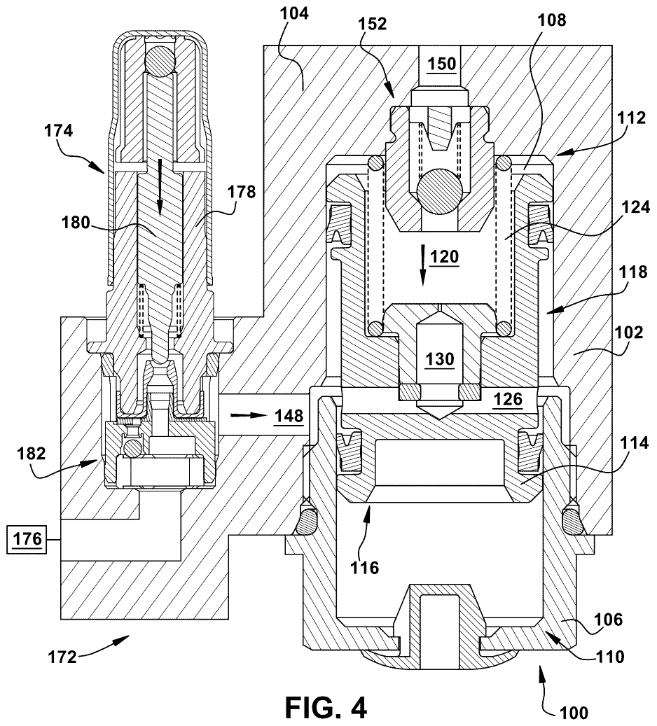

With reference now to FIG. 4, the flow intensifier 100 is “blocked” against accepting further brake fluid, with the intensifier piston 114 located adjacent to, or even “bottoming out” against, the second cavity end 112.

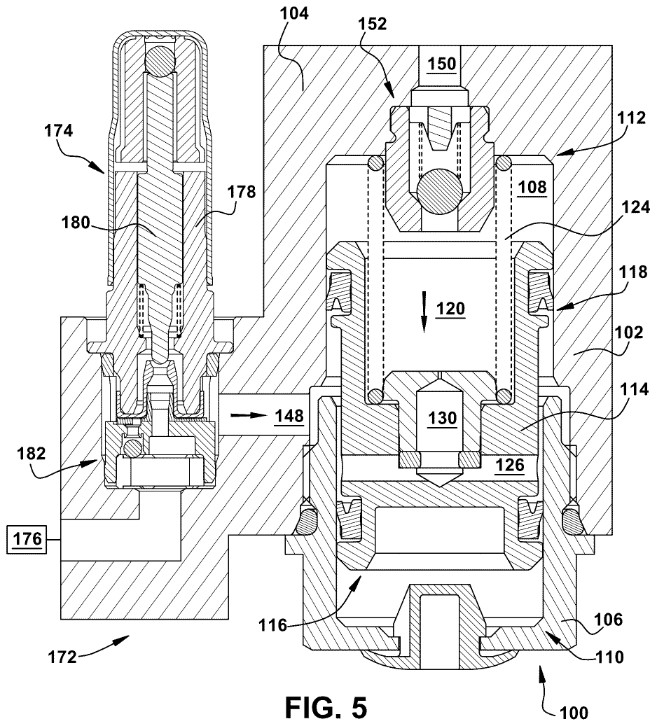

Finally, in FIG. 5, the bypass iso valve 174 has been de-energized and is once again open for supplying pressurized hydraulic fluid from the master cylinder 176. The flow intensifier 100 is refilling with fluid (from the master cylinder 176 via the bypass iso valve 174), and the intensifier piston 114 is moving back toward the first cavity end 100 at least partially under force from the intensifier piston spring 124.

If the bypass iso valve 174 shown in FIGS. 2-5 were to be of a normally-closed type, then a larger orifice size could be provided for a similarly sized solenoid as is in the normally-open version. This could be helpful in some use environments, but could result in a less-preferred nonpowered evac and fill operation than in the normally-open version shown in FIGS. 2-5. One of ordinary skill in the art can readily provide a bypass iso valve 174 configured for a particular use environment, while taking into account the various advantages and considerations relating to each design choice.

FIG. 6 schematically depicts an example brake system 184 for actuating a plurality of wheel brakes 186 comprising first and second pairs of wheel brakes 186. The brake system 184 is shown here as a hydraulic braking system, in which fluid pressure is utilized to apply braking forces for the brake system 184. The brake system 184 may suitably be used on a ground vehicle, such as an automotive vehicle having four wheels with a wheel brake associated with each wheel. Furthermore, the brake system 184 can be provided with other braking functions such as anti-lock braking (ABS) and other slip control features to effectively brake the vehicle. Components of the brake system 184 may be housed in one or more blocks or housings. The blocks or housings may be made from solid material, such as aluminum, that has been drilled, machined, or otherwise formed to house the various components. Fluid conduits may also be formed in the block or housing.

In the illustrated embodiment of the brake system 184 of FIG. 6, there are four wheel brakes 186, which each can have any suitable wheel brake structure operated electrically and/or by the application of pressurized brake fluid. Each of the wheel brakes 186 may include, for example, a brake caliper mounted on the vehicle to engage a frictional element (such as a brake disc) that rotates with a vehicle wheel to effect braking of the associated vehicle wheel. The wheel brakes 186 can be associated with any combination of front and rear wheels of the vehicle in which the corresponding brake system 184 is installed. For example, the brake system 184 may be configured as a vertically split or diagonally split system. No differentiation is made herein among the construction of the various wheel brakes 186, for the purposes of this description, though one of ordinary skill in the art could readily provide a suitable braking arrangement for a particular use environment. The wheel brakes 186 are described herein as comprising first and second pairs of wheel brakes 186, with the first and second pairs being characterized as RF/LR and LF/RR, as shown as FIG. 6, for the sake of description. However, LF/LR and RF/RR, or RF/LF and RR/LR, pairs could also or instead be specified for the brake system 184, as desired.

Also for the sake of description, it is presumed that a deceleration signal transmitter (shown schematically at 188) is configured to provide a braking signal, in a wired or wireless manner, corresponding to a desired braking action by an operator of the vehicle. The deceleration signal transmitter 188 could include, but not be limited to, a brake pedal, an autonomous braking controller, and/or any other suitable scheme for generating a braking signal from which the brake system 184 can be actuated.

The brake system 184 also includes a fluid reservoir 190. The reservoir 190 stores and holds hydraulic fluid for the brake system 184. The fluid within the reservoir 190 is preferably held at or about atmospheric pressure, but the fluid may be stored at other pressures if desired. The reservoir 190 is shown schematically as having three tanks or sections in FIG. 6, with fluid conduit lines connected thereto. The sections can be separated by several interior walls within the reservoir 190 and are provided to prevent complete drainage of the reservoir 190 in case one of the sections is depleted due to a leakage via one of the three lines connected to the reservoir 190. Alternatively, the reservoir 190 may include multiple separate housings. The reservoir 186 may include at least one fluid level sensor for detecting the fluid level of one or more of the sections of the reservoir 190.

The motor-driven master cylinder (“MC” or “[primary] power transmission unit”) 176 (which may be a dual-chamber type master cylinder 176, also known as a tandem power transmission unit) of the brake system 184 functions as a source of pressure to provide a desired pressure level to the hydraulically operated wheel brakes 186 during a typical or normal non-failure brake apply. An example of a suitable MC 176 arrangement is disclosed in co-pending U.S. patent application Ser. No. 17/708,070, filed 30 Mar. 2022 and titled “Tandem Power Transmission Unit and Brake Systems Using Same” (attorney docket no. 211835-US-NP), which is incorporated by reference herein in its entirety for all purposes. The master cylinder 176 is operable during a normal non-failure braking mode by actuation of an electric motor of the master cylinder 176 to generate brake actuating pressure at first and second MC outputs 192 and 194, respectively, for hydraulically actuating the first and second pairs of wheel brakes 186.

After a brake apply, fluid from the wheel brakes 186 may be returned to the master cylinder 176 and/or be diverted to the reservoir 190. It is also contemplated that other configurations (not shown) of the brake system 184 could include hydraulic control of just selected one(s) of the wheel brakes (with the others being electrically controlled/actuated). One of ordinary skill in the art would be readily able to provide such an arrangement for a desired use environment, following aspects of the present invention.

A secondary brake module is configured for selectively providing pressurized hydraulic fluid at first and second pump outputs 196 and 198, respectively, for actuating the first and second pairs of wheel brakes 186 in at least one of a normal non-failure braking mode and a backup braking mode. As shown in FIG. 6, the secondary brake module includes at least one pump piston 200 associated with at least one wheel brake 186 of the plurality of wheel brakes 186. The pump piston 200 is driven by an eccentric bearing (not shown) on a shaft of an electric pump motor 202 (as differentiated from the electric motor included in the master cylinder 176) which transmits rotary motion to each pump piston 200 for selectively providing pressurized hydraulic fluid to an iso/dump control valve arrangement of at least one wheel brake 186 which is associated with the pump piston 200. FIG. 6 shows one pump piston 200 as being associated with two wheel brakes 186, for a total of two pump pistons 200 in the brake system 184. Together, the pump piston(s) 200 and electric pump motor 202 can be considered to comprise a secondary brake module (A.K.A. “secondary power transmission unit”) of the brake system 184. For example, the two pump pistons 200 shown in the Figures may provide pressurized hydraulic fluid at first and second pump outputs 196 and 198, respectively, to the corresponding wheel brakes 186 via the corresponding iso/dump control valve arrangements (when present), to actuate the first and second pairs of wheel brakes 186 in at least one of a normal non-failure braking mode and a backup braking mode. Each of the first and second pump outputs 196 and 198 can provide fluid to a corresponding one of the first and second pairs of wheel brakes 186. It is contemplated that a plurality of pump pistons 200 could be associated with each of the first and second pump outputs 196 and 198, in some configurations of the brake system 184.

The secondary brake module of the brake system 184 may function as a source of pressure to provide a desired pressure level to selected ones of the wheel brakes 186 in a backup or “failed” situation, when, for some reason, the master cylinder 176 is unable to provide fluid to those selected wheel brakes 186. Accordingly, the secondary brake module may be directly or indirectly fluidly connected to the reservoir 190, for exchanging hydraulic fluid between these components without having to route the fluid through a (potentially failed) motor-driven master cylinder 176 or another structure of the brake system 184.

The secondary brake module can be used to selectively provide hydraulic fluid to at least one of the wheel brakes 186 in a backup braking mode, but also in an enhanced braking mode, which can occur on its own and/or concurrently with either the backup braking mode or a non-failure normal braking mode. Examples of suitable enhanced braking mode functions available to the brake system 184 may include, but not be limited to, “overboost” (in which higher pressure is provided to a particular brake than would normally be available from the master cylinder 176 alone) and “volume-add” (in which more fluid is provided to a particular brake than would normally be available from the master cylinder 176). These enhanced braking modes may be facilitated, in some use environments, by the pump piston(s) 200.

The brake system 184 shown in FIG. 6 also includes at least one electronic control unit (“ECU”) 204, for controlling at least one of the master cylinder 176 and the secondary brake module (via electric pump motor 202) responsive to at least one braking signal, with first and second ECUs 204A, 204B being shown and described herein. The ECUs 204A, 204B may include microprocessors and other electrical circuitry. The ECUs 204A, 204B receive various signals, process signals, and control the operation of various electrical components of a corresponding brake system 184 in response to the received signals, in a wired and/or wireless manner. The ECUs 204A, 204B can be connected to various sensors such as the reservoir fluid level sensor(s), pressure sensors, travel sensors, switches, wheel speed sensors, and steering angle sensors. The ECUs 204A, 204B may also be connected to an external module (not shown) for receiving information related to yaw rate, lateral acceleration, longitudinal acceleration of the vehicle, or other characteristics of vehicle operation for any reason, such as, but not limited to, controlling the brake system 100 during vehicle braking, stability operation, or other modes of operation. Additionally, the ECUs 204A, 204B may be connected to the instrument cluster for collecting and supplying information related to warning indicators such as an ABS warning light, a brake fluid level warning light, and a traction control/vehicle stability control indicator light. It is contemplated that at least one of the ECUs 204A and 204B may be, for example, integrated with the master cylinder 176 or the electric pump motor 202.

The first and second ECUs 204A and 204B may divide the control tasks for the brake system 100 in any desired manner, and may be readily configured by one of ordinary skill in the art for a particular use environment of a brake system, though it is contemplated that any control tasks performed by one or more ECUs 204 will be accomplished responsive to at least one brake pressure signal and/or a braking signal produced by the deceleration signal transmitter 188. For example, the first ECU 204A may be operative to control the electric motor of the master cylinder 176. The second ECU 204B may be operative to control the electric pump motor 202, and potentially, as will now be discussed, at least one of the iso/dump control valve arrangements, at least one of the bypass iso valves 174, and/or at least one of the first and second traction control iso valves.

An iso/dump control valve arrangement is shown in FIG. 6 as being associated with each wheel brake 186 of the plurality of wheel brakes 186. Each iso/dump control valve arrangement includes an iso valve 206 and a dump valve 208, for providing desired fluid routing to an associated wheel brake 186. The reservoir 186 is hydraulically connected to the master cylinder 176 and to each of the iso/dump control valve arrangements, such as via the return line 216. The iso/dump control valve arrangements each include respective serially arranged iso and dump valves 206 and 208. The normally open iso valve 206 for each iso/dump control valve arrangement is located hydraulically between a respective wheel brake 186 and the master cylinder 176 and the normally closed dump valve 208 for each iso/dump control valve arrangement is located hydraulically between a respective wheel brake 186 and the reservoir 186, for the corresponding wheel brake 186.

The iso/dump control valve arrangements may selectively provide slip control to at least one wheel brake 186 powered by the master cylinder 176 and/or the secondary brake module previously mentioned. More broadly, the iso/dump control valve arrangement, and/or other valves of the brake system 184, any of which may be solenoid-operated and have any suitable configurations, can be used to help provide controlled braking operations, such as, but not limited to, ABS, traction control, vehicle stability control, dynamic rear proportioning, regenerative braking blending, and autonomous braking. Each iso/dump control valve arrangement is controlled by at least a chosen one of the electronic control units 204A, 204B.

A first traction control iso valve 210 is hydraulically interposed between the master cylinder 176 and at least one iso/dump control valve arrangement via the first MC output 192. A second traction control iso valve 212 is hydraulically interposed between the master cylinder 176 and at least one iso/dump control valve arrangement via the second MC output 194. As shown in FIG. 6, it is contemplated that an iso/dump control valve arrangement may be associated with each wheel brake 186 of the first and second pairs of wheel brakes. The first traction control iso valve 210 is hydraulically interposed between the motor-driven master cylinder 176 and the iso/dump control valve arrangements of the first pair of wheel brakes 186. Similarly, the second traction control iso valve 212 is hydraulically interposed between the motor-driven master cylinder 176 and the iso/dump control valve arrangements of the second pair of wheel brakes 186.

As can be seen, each iso/dump control valve arrangement in the brake system 184 of FIG. 6 is in direct or indirect fluid communication with both a selected one of the first and second MC outputs 192 and 194 and a selected one of the first and second pump outputs 196 and 198 for selectively receiving pressurized fluid therefrom, such as during different braking modes or otherwise as desired. One of ordinary skill in the art will be readily able to configure a brake system 184 for any particular use application as desired.

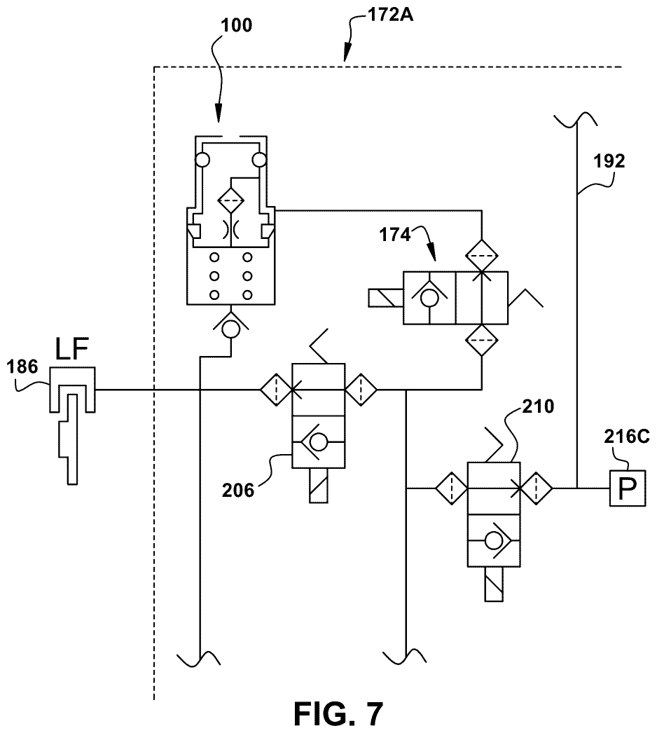

Similarly, and as previously alluded to, the brake system 184 of FIG. 6 has first and second intensifier assemblies 172A and 172B, respectively, with each of the first and second intensifier assemblies 172A and 172B having a nonpowered flow intensifier 100 and optionally a bypass iso valve 174. Each of the first and second intensifier assemblies 172A and 173B is interposed hydraulically directly or indirectly between a corresponding first or second MC output 192 or 194 and at least one wheel brake 186 of a corresponding first or second pair of wheel brakes. (It is contemplated that at least one corresponding iso/dump control valve arrangement could be interposed hydraulically between the flow intensifiers 100 and the wheel brakes 186.) Each of the powered bypass iso valves 174, when present, is interposed hydraulically between the respective first or second MC output 192 or 194 and the respective flow intensifier 100. This arrangement is shown schematically, for example, in FIG. 7. The first and second intensifier assemblies 172A and 172B of the brake system 184 each may facilitate, for example, a rapid filling operation for low drag brake calipers of the respective wheel brakes 186.

The brake system 184 may also include at least one air over oil accumulator 214 interposed hydraulically between the reservoir 190 and at least one corresponding pump piston 200 for damping fluid flow at the inlet of the respective piston pump 202, and may be provided by one of ordinary skill in the art for a particular use environment of the brake system 184.

A brake pressure signal is at least one input that an ECU 204 may consider and responsively control one or more other components of the brake system 184, to achieve desired braking results for a particular use environment. One potential source of the brake pressure signal is a brake pressure sensor. For example, and as shown in the Figures, the brake system 184 can include at least one brake pressure sensor 216. As can be seen in FIG. 6, a first brake pressure sensor 216A may be interposed hydraulically between a selected iso/dump control valve arrangement and a corresponding rear brake of a chosen one of the first and second pairs of wheel brakes 186, and a second brake pressure sensor 216B may be interposed hydraulically between an other iso/dump control valve arrangement and a corresponding rear brake of an other one of the first and second pairs of wheel brakes 186. Either along with or instead of the first and second brake pressure sensors 216A, 216B, a third brake pressure sensor 216C may be interposed hydraulically between the first traction control iso valve 210 and the master cylinder 176, and/or a fourth brake pressure sensor 216D may be interposed hydraulically between the second traction control iso valve 212 and the master cylinder 176. One of ordinary skill in the art can readily provide a desired number/position/type of pressure sensors 216 for a particular brake system 100.

With reference again to FIG. 6, the reservoir 190 and motor-driven master cylinder 176 may be co-located in a first housing (indicated schematically by dashed line “1” in those Figures), and the secondary brake module may be located in a second housing (indicated schematically by dashed line “2” in those Figures), spaced apart from the first housing. Optionally, and also as shown in FIG. 6, the iso/dump control valve arrangements, the first and second intensifier assemblies 172A and 172B, and/or the first and second traction control iso valves 210 and 212 may also be located in the second housing.

The first and second housings (and included/co-located components) of any brake systems 178 may be provided and configured for a particular use application by one of ordinary skill in the art based upon factors including, but not limited to, achieving desired outcomes in at least one of design, manufacturing, service, spatial utilization in the vehicle, cost, size, regulatory compliance, or the like.

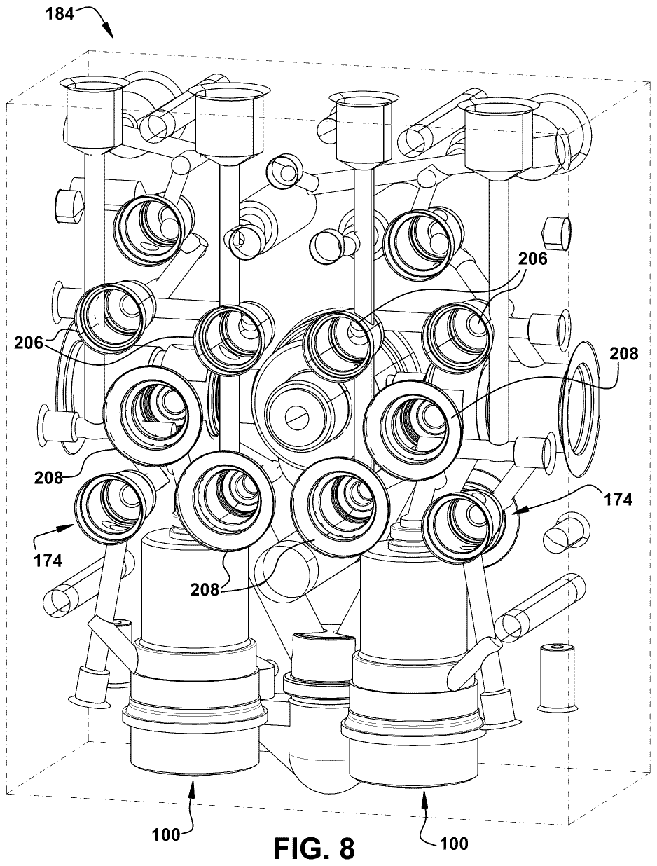

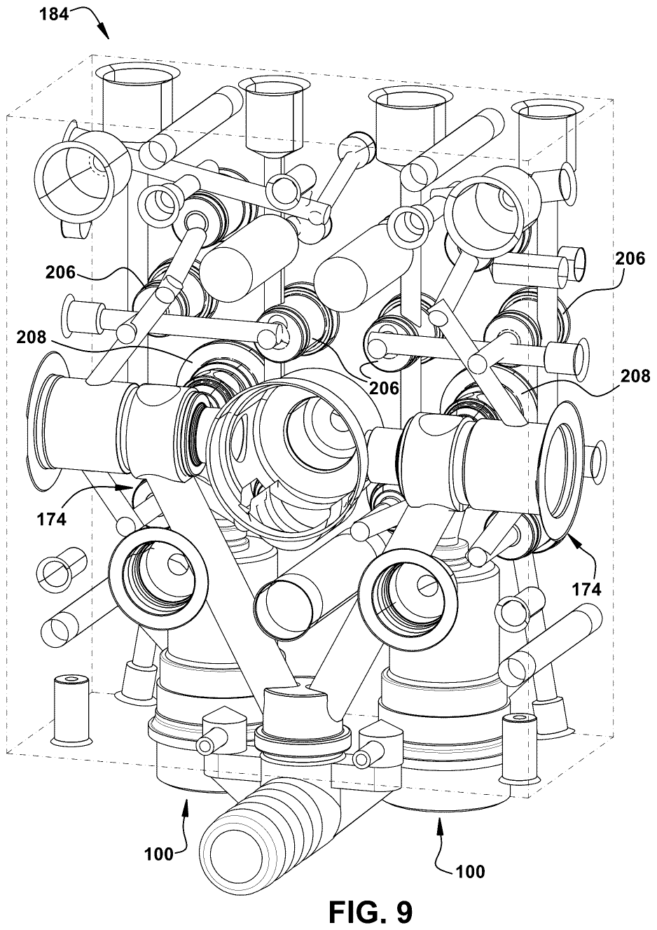

FIGS. 8-9 schematically depict an example arrangement, from opposite front/rear sides, of a block housing 104 of a brake system 184 according to the previous description and shown in FIG. 6. In FIGS. 8-9, the block housing 104 is shown as a rectangular prism, with bores or cavities machined or otherwise produced therein for, or connecting fluidly to, the components as labeled. As can be seen in FIGS. 8-9, for example, the block housing 104 is similar to known block housings for other brake systems having low pressure accumulators and associated supply valves, but with the flow intensifiers 100 and bypass iso valves 174 of the intensifier assembly 172 in place of at least some of those components, respectively. This may assist with ease of design, manufacturing, sourcing, assembly, or otherwise be helpful in transitioning between use of the known block housings (for the prior art brake systems) and the block housing 104 associated with the present brake system 184. One of ordinary skill in the art can readily provide a block housing 104 configured to fit in a desired package configuration for a particular use environment.

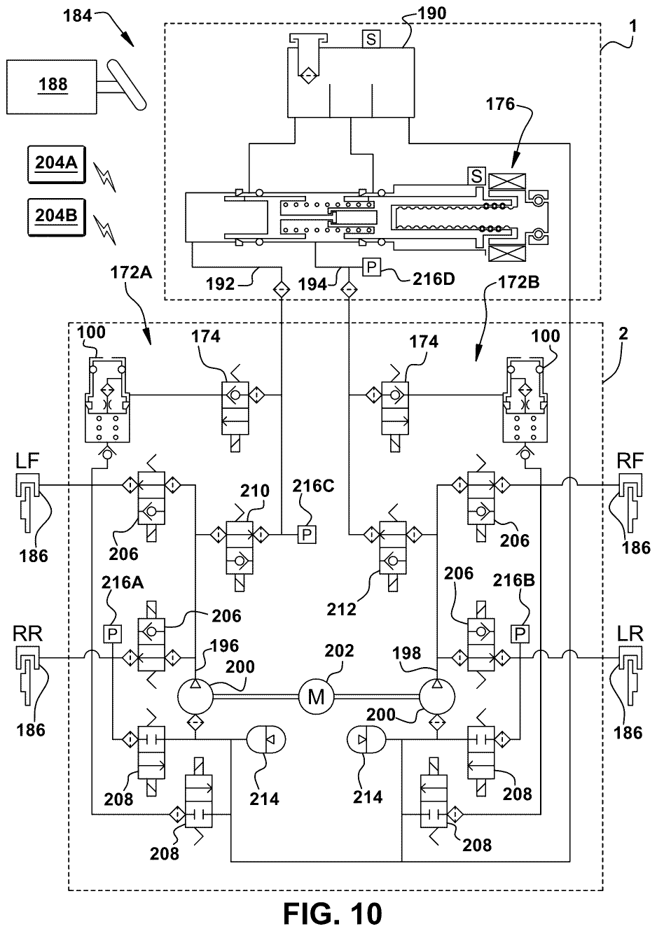

Finally, FIG. 10 schematically depicts an example brake system 184 wherein the first and second intensifier assemblies 172A and 172B are each directly hydraulically connected to the respective first or second MC output 194 or 196, without the interposed first or second TC iso valve 210 or 212, as in the FIG. 6 diagram. In the brake system 184 shown in FIG. 10, the bypass iso valves 174 are shown as normally-closed, but it is also contemplated that normally-open bypass iso valves 174 could instead be used, as desired. By virtue of connecting the first and second intensifier assemblies 172A and 172B directly to the respective first or second MC output 194 or 196, without the interposed first or second TC iso valve 210 or 212, there will be lower total flow restriction between the master cylinder 176 and the wheel brakes 186, which may result in faster brake application in a “spike apply” situation. However, the secondary brake module cannot use the flow intensifiers 100 in the FIG. 10 brake system 184. Also, physical arrangement of the FIG. 10 brake system 184 into a block housing 104 (similar to the FIG. 6 brake system 184 block housing 104 shown in FIGS. 8-9) could be more difficult due to the “direct” routing. One of ordinary skill in the art can readily provide a desired brake system 184 for a particular use environment given the understanding that the bypass iso valve 174 may be directly hydraulically connected to the respective first or second MC output 194 or 196 and/or indirectly hydraulically connected to the respective first or second MC output 194 or 195 via a fluidically interposed respective first or second traction control iso valve 210 or 212.

It is contemplated that various other components, such as electric service and/or parking brake motors, could be provided by one of ordinary skill in the art to achieve desired configurations for particular use environments, in the brake system 184 described herein. For example, while a number of filters, o-ring and other seals, and pressure or other sensors are shown in the Figures, specific description thereof has been omitted herefrom for brevity, as one of ordinary skill in the art will readily understand how to provide a desired number, placement, and/or operation of filters, sensors, and any other components as desired for a particular use environment of the present invention.

It is contemplated that, while the various components are shown schematically in certain arrangements in the Figures, the components might not reach the precise relative configurations shown, depending on operating conditions in a particular use environment. For example, a poppet might not shuttle to entirely occlude an associated valve seat. However, one of ordinary skill in the art will understand which potential other positions may substantially produce a desired outcome, for a particular use environment. Various orifice sizes, fluid paths, hydraulic passageways, and other components of the intensifier assembly 172 can be configured by one of ordinary skill in the art to achieve desired operational characteristics of the intensifier assembly 172 in a particular use environment.

As used herein, the singular forms “a”, “an”, and “the” can include the plural forms as well, unless the context clearly indicates otherwise. It will be further understood that the terms “comprises” and/or “comprising”, as used herein, can specify the presence of stated features, steps, operations, elements, and/or components, but do not preclude the presence or addition of one or more other features, steps, operations, elements, components, and/or groups thereof.

As used herein, the term “and/or” can include any and all combinations of one or more of the associated listed items.

It will be understood that when an element is referred to as being “on”, “attached” to, “connected” to, “coupled” with, “contacting”, “adjacent”, etc., another element, it can be directly on, attached to, connected to, coupled with, contacting, or adjacent the other element, or intervening elements may also be present. In contrast, when an element is referred to as being, for example, “directly on”, “directly attached” to, “directly connected” to, “directly coupled” with, “directly contacting”, or “directly adjacent” another element, there are no intervening elements present. It will also be appreciated by those of ordinary skill in the art that references to a structure or feature that is disposed “directly adjacent” another feature may have portions that overlap or underlie the adjacent feature, whereas a structure or feature that is disposed “adjacent” another feature might not have portions that overlap or underlie the adjacent feature.

Spatially relative terms, such as “under”, “below”, “lower”, “over”, “upper”, “proximal”, “distal”, and the like, may be used herein for ease of description to describe one element or feature's relationship to another element(s) or feature(s) as illustrated in the figures. It will be understood that the spatially relative terms can encompass different orientations of a device in use or operation, in addition to the orientation depicted in the figures. For example, if a device in the figures is inverted, elements described as “under” or “beneath” other elements or features would then be oriented “over” the other elements or features.

As used herein, the phrase “at least one of X and Y” can be interpreted to include X, Y, or a combination of X and Y. For example, if an element is described as having at least one of X and Y, the element may, at a particular time, include X, Y, or a combination of X and Y, the selection of which could vary from time to time. In contrast, the phrase “at least one of X” can be interpreted to include one or more Xs.

It will be understood that, although the terms “first”, “second”, etc. may be used herein to describe various elements, these elements should not be limited by these terms. These terms are only used to distinguish one element from another. Thus, a “first” element discussed below could also be termed a “second” element without departing from the teachings of the present disclosure. The sequence of operations (or steps) is not limited to the order presented in the claims or figures unless specifically indicated otherwise.

While aspects of this disclosure have been particularly shown and described with reference to the example aspects above, it will be understood by those of ordinary skill in the art that various additional aspects may be contemplated. For example, the specific methods described above for using the apparatus are merely illustrative; one of ordinary skill in the art could readily determine any number of tools, sequences of steps, or other means/options for placing the above-described apparatus, or components thereof, into positions substantively similar to those shown and described herein. In an effort to maintain clarity in the Figures, certain ones of duplicative components shown have not been specifically numbered, but one of ordinary skill in the art will realize, based upon the components that were numbered, the element numbers which should be associated with the unnumbered components; no differentiation between similar components is intended or implied solely by the presence or absence of an element number in the Figures. Any of the described structures and components could be integrally formed as a single unitary or monolithic piece or made up of separate sub-components, with either of these formations involving any suitable stock or bespoke components and/or any suitable material or combinations of materials. Any of the described structures and components could be disposable or reusable as desired for a particular use environment. Any component could be provided with a user-perceptible marking to indicate a material, configuration, at least one dimension, or the like pertaining to that component, the user-perceptible marking potentially aiding a user in selecting one component from an array of similar components for a particular use environment. A “predetermined” status may be determined at any time before the structures being manipulated actually reach that status, the “predetermination” being made as late as immediately before the structure achieves the predetermined status. The term “substantially” is used herein to indicate a quality that is largely, but not necessarily wholly, that which is specified—a “substantial” quality admits of the potential for some relatively minor inclusion of a non-quality item. Though certain components described herein are shown as having specific geometric shapes, all structures of this disclosure may have any suitable shapes, sizes, configurations, relative relationships, cross-sectional areas, or any other physical characteristics as desirable for a particular application. Any structures or features described with reference to one aspect or configuration could be provided, singly or in combination with other structures or features, to any other aspect or configuration, as it would be impractical to describe each of the aspects and configurations discussed herein as having all of the options discussed with respect to all of the other aspects and configurations. A device or method incorporating any of these features should be understood to fall under the scope of this disclosure as determined based upon the claims below and any equivalents thereof.

Other aspects, objects, and advantages can be obtained from a study of the drawings, the disclosure, and the appended claims.

I claim:

1. A nonpowered flow intensifier, comprising:
an intensifier housing;
an intensifier cavity at least partially defined by the intensifier housing, the intensifier cavity having longitudinally spaced first and second cavity ends with a central cavity axis extending longitudinally therebetween;
an intensifier piston configured for selective longitudinally reciprocal motion within the intensifier cavity, at least partially responsive to fluid pressure within the intensifier cavity, the intensifier piston including
a piston head portion longitudinally adjacent the first cavity end,
a piston skirt portion extending from the piston head portion toward the second cavity end,
a piston lateral bore extending in a lateral direction at least partially through a solid body of the piston head portion and in fluid communication with the intensifier cavity via at least one lateral bore outlet of the piston head portion,
a piston reducer bore placing the piston lateral bore and an internal void of the piston skirt portion in fluid communication;
a fluid input port interposed longitudinally between the first and second cavity ends and placing the intensifier cavity in fluid communication with a source of pressurized hydraulic fluid; and
a fluid output port located at the second cavity end and placing the intensifier cavity in fluid communication with a wheel brake;
wherein pressurized hydraulic fluid travels along an intensifier input fluid path at least from the fluid input port, through at least a portion of the intensifier cavity, the piston lateral bore, the piston reducer bore, and the internal void of the piston skirt, and exits the intensifier cavity via the fluid output port.

2. The flow intensifier of claim 1, wherein the intensifier piston includes a stepped outer profile shape, with a total outer diameter of the intensifier piston adjacent the first cavity end being smaller than a total outer diameter of the intensifier piston adjacent the second cavity end.

3. The flow intensifier of claim 1, wherein the intensifier housing is cooperatively formed by a bore in a brake system housing block and a cap attached to the brake system housing block.

4. The flow intensifier of claim 1, including a vent to atmospheric pressure located at the first cavity end.

5. The flow intensifier of claim 4, wherein a surface of the piston head portion directly adjacent the vent includes a longitudinally extending vent bore to accommodate extension of the vent thereinto while a portion of the surface of the piston head portion, which does not include the vent bore, is laterally adjacent to at least a portion of the vent.

6. The flow intensifier of claim 1, wherein the fluid output port includes a port check valve resisting fluid flow from the wheel brake toward the intensifier cavity.

7. The flow intensifier of claim 6, wherein the port check valve includes a check valve seat and a check valve ball urged toward the first cavity end and into engagement with the check valve seat by a check valve spring, wherein a spring retainer prevents egress of the check valve spring from the port check valve, the check valve ball being longitudinally interposed between the check valve seat and the spring retainer.

8. The flow intensifier of claim 1, wherein the intensifier piston includes a first lip seal carried within a first lip seal groove at least partially circumferentially surrounding the piston head portion and resisting fluid flow in a direction from the second cavity end toward the first cavity end, and a second lip seal carried within a second lip seal groove at least partially circumferentially surrounding the piston skirt portion and resisting fluid flow in a direction from the first cavity end toward the second cavity end.

9. The flow intensifier of claim 8, wherein the second lip seal groove is carried in an increased-diameter stepped area of the piston skirt portion, the stepped area including a piston shoulder longitudinally interposed between the second lip seal groove and the lateral bore outlet, wherein pressurized hydraulic fluid from the fluid input port pushes against the piston shoulder to urge the intensifier piston toward the second cavity end.

10. The flow intensifier of claim 1, wherein an internal surface of the piston skirt portion includes a laterally extending internal piston face against which an intensifier piston spring acts to urge the intensifier piston toward the first cavity end, the internal piston face including a reducer recess extending into a solid body of the piston head portion, the reducer recess being in fluid communication with the piston lateral bore, and wherein the piston reducer bore is at least partially defined by a reducer plug carried at least partially within the reducer recess and defining a center plug bore with a first plug diameter adjacent the piston lateral bore and a second plug diameter, which is a superminority of the first plug diameter, adjacent the piston skirt portion and longitudinally spaced from the first plug diameter along the center plug bore.

11. The flow intensifier of claim 10, including a filter interposed longitudinally between the reducer plug and at least a portion of the piston lateral bore.

12. A brake system for actuating a plurality of wheel brakes comprising first and second pairs of wheel brakes, the system comprising:
a reservoir;
a motor-driven master cylinder operable during a normal non-failure braking mode by actuation of an electric motor of the master cylinder to generate brake actuating pressure at first and second MC outputs for hydraulically actuating the first and second pairs of wheel brakes, respectively;
a secondary brake module configured for selectively providing pressurized hydraulic fluid at first and second pump outputs for actuating the first and second pairs of wheel brakes in at least one of a normal non-failure braking mode and a backup braking mode, the secondary brake module including an electric pump motor configured to selectively pressurize the hydraulic fluid by transmitting rotary motion to at least two pump pistons, each pump piston providing pressurized hydraulic fluid to a corresponding one of the first and second pump outputs, each of the first and second pump outputs providing fluid to a corresponding one of the first and second pairs of wheel brakes;
first and second intensifier assemblies, with each intensifier assembly being interposed hydraulically between a corresponding first or second MC output and at least one wheel brake of a corresponding first or second pair of wheels, each of the first and second intensifier assemblies including a nonpowered flow intensifier, the flow intensifier including
an intensifier housing;
an intensifier cavity at least partially defined by the intensifier housing, the intensifier cavity having longitudinally spaced first and second cavity ends with a central cavity axis extending longitudinally therebetween;
an intensifier piston configured for selective longitudinally reciprocal motion within the intensifier cavity, at least partially responsive to fluid pressure within the intensifier cavity, the intensifier piston including
a piston head portion longitudinally adjacent the first cavity end,
a piston skirt portion extending from the piston head portion toward the second cavity end,
a piston lateral bore extending in a lateral direction at least partially through a solid body of the piston head portion and in fluid communication with the intensifier cavity via at least one lateral bore outlet of the piston head portion,
a piston reducer bore placing the piston lateral bore and an internal void of the piston skirt portion in fluid communication;
a fluid input port interposed longitudinally between the first and second cavity ends and placing the intensifier cavity in fluid communication with a respective first or second MC output; and
a fluid output port located at the second cavity end and placing the intensifier cavity in fluid communication with a respective wheel brake; and
an electronic control unit for controlling at least one of the secondary brake module and the master cylinder responsive to at least one braking signal;
wherein the first and second intensifier assemblies each facilitate a rapid filling operation for low drag brake calipers of the respective wheel brakes.

13. The brake system of claim 12, including an air over oil accumulator interposed hydraulically between the reservoir and at least one pump piston for damping fluid flow at the inlet of the respective piston pump.

14. The brake system of claim 12, wherein each of the first and second intensifier assemblies includes a bypass iso valve interposed hydraulically between the respective first or second MC output and the respective flow intensifier.

15. The brake system of claim 14, wherein the bypass iso valve is a chosen one of a normally open bypass iso valve and a normally closed bypass iso valve.

16. The brake system of claim 12, including a first traction control iso valve hydraulically interposed between the motor-driven master cylinder and the first intensifier assembly via the first MC outlet; and
a second traction control iso valve hydraulically interposed between the motor-driven master cylinder and the second intensifier assembly via the second MC outlet.

17. The brake system of claim 16, wherein each of the first and second intensifier assemblies includes a bypass iso valve interposed hydraulically between the respective first or second MC output and the respective flow intensifier, and wherein the bypass iso valve is a chosen one of directly hydraulically connected to the respective first or second MC output, and indirectly hydraulically connected to the respective first or second MC output via a fluidically interposed respective first or second traction control iso valve.

18. The brake system of claim 12, including an iso/dump control valve arrangement associated with each wheel brake of the plurality of wheel brakes, each iso/dump control valve arrangement being controlled by the electronic control unit, and a chosen one of the first and second intensifier assemblies being interposed hydraulically between a corresponding one of the first and second MC outputs and at least one associated iso/dump control valve arrangement.

19. The brake system of claim 18, wherein a first brake pressure sensor is interposed hydraulically between a selected iso/dump control valve arrangement and a corresponding rear brake of a chosen one of the first and second pairs of wheel brakes, and a second brake pressure sensor is interposed hydraulically between an other iso/dump control valve arrangement and a corresponding rear brake of an other one of the first and second pairs of wheel brakes.

20. The brake system of claim 12, wherein the reservoir and master cylinder are co-located in a first housing and the secondary brake module is located in a second housing, spaced apart from the first housing and including the intensifier housing.
